(19) United States
(12) Patent Application Publication
(10) Pub. No.: US 2006/0000872 A1
(43) Pub. Date: Jan. 5, 2006

(54) Printed circuit board inspection device, printed circuit board assembly inspection line system, and computer-readable medium having program recorded thereon

(76) Inventors: Hiromitsu Nakagawa, Tokyo (JP); Hideki Takahashi, Kanagawa (JP); Katsuhiko Mukai, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/153,457

(22) Filed: Jun. 16, 2005

(30) Foreign Application Priority Data
Jun. 30, 2004 (JP) 2004-193001

(51) Int. Cl. B23K 5/22; B23K 31/12

(52) U.S. Cl. 228/56.5; 228/103; 228/33

(57) ABSTRACT

A printed circuit board inspection device is disclosed that is configured to measure the shape of a pasted solder and the shape of parts after mounting the parts in an inspection of a solder paste on a printed circuit board. This printed circuit board inspection device for a printed circuit board on which a solder paste is printed and at least one part is mounted on the solder paste, includes an inspecting section. The inspecting section calculates an amount of the solder paste not covered by an electrode of the part mounted on the solder paste based on image data captured by an imaging device, the image data showing the part mounted on the solder paste. If the calculated amount of not-covered solder paste is greater than a predetermined upper limit or smaller than a predetermined lower limit, the inspecting section determines that the solder paste is incorrectly printed.

### BACKGROUND OF THE INVENTION

1. Field of the Invention

The present invention relates to a technique for checking whether mounted parts are correctly soldered on a printed circuit board, and particularly relates to an inspection technique for accurately predicting soldering defects before soldering the parts in a reflow oven.

2. Description of the Related Art

In printed circuit board assemblies, visual inspections by human eyes or by appearance inspection devices that replace human eyes have been conducted to check whether mounted parts are correctly soldered.

For example, Japanese Patent Laid-Open Publication No. 10-311807 (hereinafter referred to as Reference 1) discloses a technique for calculating reference states of solders deformed by area array parts such as BGA (Ball Grid Array) and CSP (Chip Scale Package) and checking the soldering quality with reference to the reference states by an inspection device using X-rays. Japanese Patent Laid-Open Publication No. 10-170455 (hereinafter referred to as Reference 2) discloses a technique for detecting a shadow of lead in a solder alloy with use of X-rays and checking the soldering quality based on the shadow.

Japanese Patent Laid-Open Publication P No. 2002-134899 (hereinafter referred to as Reference 3) discloses an inspection line technique. According to this technique, an inspection is performed after each process, including an inspection of solder printed states after a printing process, an inspection of part mounted states of mounted parts after a mounting process, and an inspection of soldered states after a reflow process. Detecting defects in theses processes with this technique assures high density mounting quality, contributes to part size reduction, and facilitates repair of defected defects. Additionally, measurement values obtained in each process are fed back and fed forward so as to provide accurate and efficient quality control.

Japanese Patent Laid-Open Publication No. 2003-110299 (hereinafter referred to as Reference 4) discloses an inspection device capable of simultaneously inspecting mounted chip parts and solder printed states of area array parts. As this inspection device can perform inspections that have been conventionally performed by two inspections devices, the amount of equipment investment is reduced.

With recent advances in high density mounting on printed circuit boards for facilitating size reduction, performance enhancement and speed improvement of products, a need for assembly inspection methods for high density mounting is increasing. On the other hand, for example, with the rise of China in the field of printed circuit board assembly, many mass-production type printed circuit boards, including printed circuit boards of easy-to-assemble and non-high density mounting types, are now produced in China. This, in turn, has increased production of a wide variety of printed circuit boards in small quantities (and occasionally large quantities) or a high-mix low-volume production in Japan.

Combinational use of a high-speed chip mounting device and an odd-shaped part mounting device, which is used to mount odd-shaped parts such as IC (Integrated Circuit) or connectors, has been popular so far. However, it is being shifted to combinational use of plural odd-shaped part mounting devices. This is because the increase of ASICs (Application Specific Integrated Circuits) has reduced the number of mounted parts. Time that can be used for arrangements and setup of these mounting devices is becoming tight.

These circumstances demonstrate a growing need for solder inspection devices, processes, and methods that are applicable in production of printed circuit boards with reduced number of parts and in high-mix low-volume production.

Conventional inspections by appearance inspection devices or human eyes after soldering cannot assure inspection quality when facing future challenges such as part size reduction, use of area array parts and improvements of mounting density.

In the case of the methods using X-rays disclosed in References 1 and 2, soldered states of area array parts that cannot be checked by appearance inspections can be checked by irradiating X-rays. However, the methods are disadvantageous in that X-ray devices are expensive, the number of X-ray operators is limited, and defect repair is difficult even if defects are detected.

The technique disclosed in Reference 3 can realize efficient quality control by providing an inspection device for each assembly process performed before a soldering process. However, with this technique, it is not possible to detect defects that occur after a part mounting (placement, installation) process, including adhesion of foreign materials such as small parts to solder printed areas of area array parts. Another issue with this technique is that an inspection device is required to be provided for each assembly process, resulting in increase of equipment investment and extra task of setting-up each inspection device. That is, this technique is effective in large volume production, but is not effective in small volume production.

The technique disclosed in Reference 4 and other similar techniques known in the art uses an inspection device, which has a function of measuring solder printed shapes on areas where parts are not mounted and measuring mounted states of the parts on areas where the parts are mounted, installed at a most effective inspection point between a high-speed chip part mounting device and an odd-shaped part mounting device, instead of using an inspection device provided for each process. These techniques are somewhat useful in high density mounting. However, soldered states on the area where the parts are mounted cannot be checked, and therefore soldered states of chip parts mounted in high density cannot be checked.

A problem with the techniques described above is that a printed state of a solder paste and mounted states of parts cannot be efficiently checked with low cost.

### SUMMARY OF THE INVENTION

An object of the present invention is to solve at least one problem described so as to improve the quality of printed circuit boards and the productivity of printed circuit boards.

To achieve the above and other objects of the present invention, in an inspection of a printed circuit board on which a solder paste is printed such that a part or parts are mounted on the solder paste, the quality is checked by not merely performing print pattern matching of a solder paste and examining the solder shapes and deformation after mounting parts, but also by calculating the amount of the solder paste not covered by electrodes after mounting the parts. In other words, the amount of the solder paste not covered by the electrodes of the parts mounted on the solder paste is calculated based on image data, which is captured by an imaging device such as a CCD camera and/or a laser measuring device, showing a state of the part mounted on the solder paste. Then, if the non-covered amount is greater than a predetermined upper limit or smaller than a predetermined lower limit, it is determined that the solder paste is incorrectly printed.

According to the present invention, states of a solder printed on the printed circuit board, mounted states of parts, and deformation of the solder under the mounted parts can be efficiently measured with a simple structure. Therefore, the present invention allows a significant reduction of defect rates of printed circuit boards and is applicable in high-density mounting and multi-mix variable-quantity production.

### BRIEF DESCRIPTION OF THE DRAWINGS

FIG. 1 is a block diagram showing an example of a configuration of a printed circuit board inspection device according to the present invention;

FIG. 2 is a block diagram showing an example of a configuration of a printed circuit board assembly inspection line system using the printed circuit board inspection device of FIG. 1 according to the present invention;

FIGS. 3A and 3B illustrate a first example of the operation of the printed circuit board inspection device of FIG. 1;

FIGS. 4A-4C illustrate a second example of the operation of the printed circuit board inspection device of FIG. 1;

FIGS. 5A-5C illustrate a third example of the operation of the printed circuit board inspection device of FIG. 1;

FIGS. 6A-6C illustrate a fourth example of the operation of the printed circuit board inspection device of FIG. 1;

FIGS. 7A-7C illustrate a fifth example of the operation of the printed circuit board inspection device of FIG. 1;

FIGS. 8A and 8B illustrate a sixth example of the operation of the printed circuit board inspection device of FIG. 1;

FIGS. 9A and 9B illustrate a seventh example of the operation of the printed circuit board inspection device of FIG. 1;

FIGS. 10A-10D illustrate an eighth example of the operation of the printed circuit board inspection device of FIG. 1;

FIGS. 11A and 11B illustrate a ninth example of the operation of the printed circuit board inspection device of FIG. 1;

FIGS. 12A and 12B illustrate a tenth example of the operation of the printed circuit board inspection device of FIG. 1;

FIGS. 13A-13C illustrate an eleventh example of the operation of the printed circuit board inspection device of FIG. 1;

FIGS. 14A and 14B illustrate a twelfth example of the operation of the printed circuit board inspection device of FIG. 1;

FIG. 15 illustrates a thirteenth example of the operation of the printed circuit board inspection device of FIG. 1; and

FIGS. 16A and 16B illustrate an example of a system configuration of the printed circuit board inspection device of FIG. 1 and an example of a table structure of a database thereof, respectively.

### DETAILED DESCRIPTION OF THE PREFERRED EMBODIMENT

An exemplary embodiment of the present invention is described below with reference to the accompanying drawings.

### Embodiment

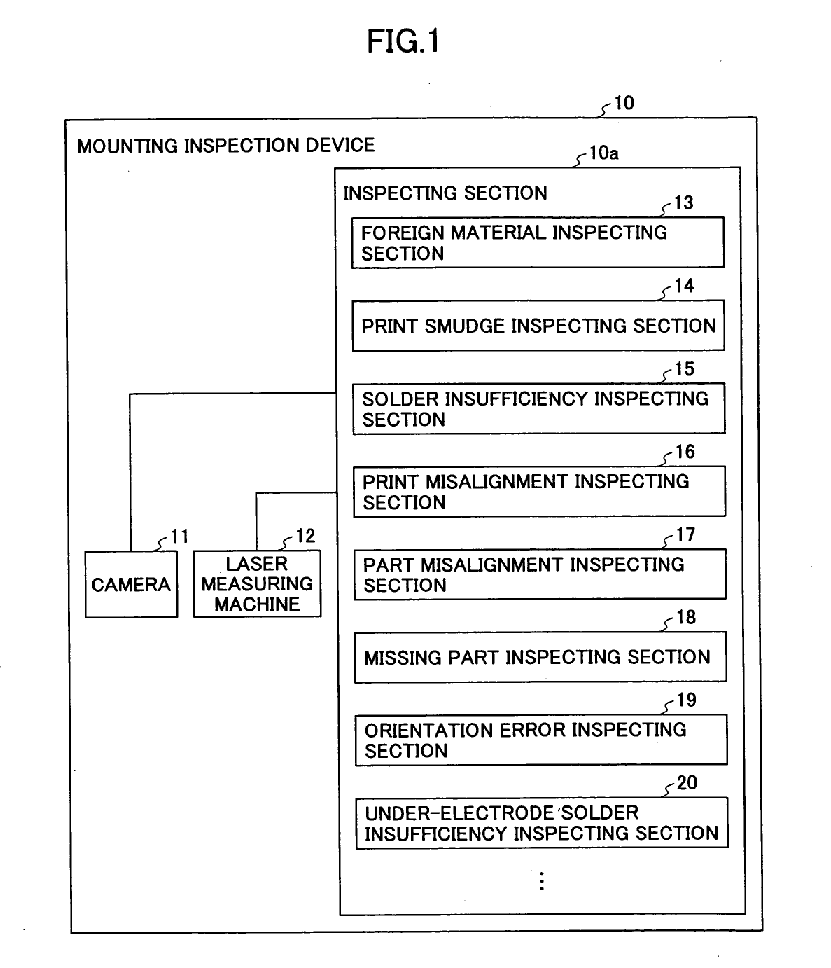

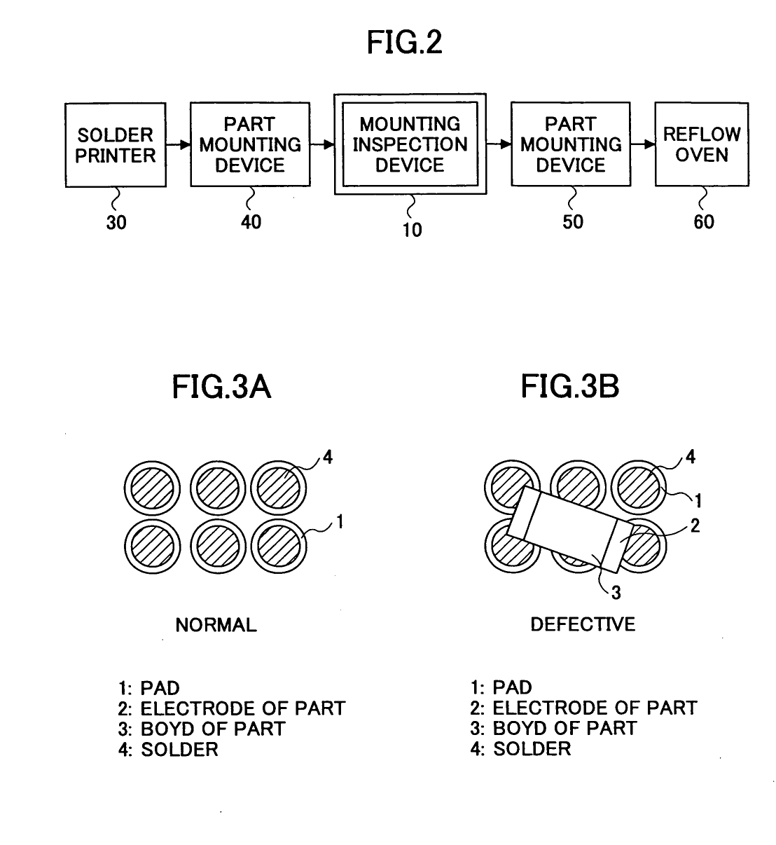

FIG. 1 is a block diagram showing an example of a configuration of a printed circuit board inspection device according to the present invention. FIG. 2 is a block diagram showing an example of a configuration of a printed circuit board assembly inspection line system using the printed circuit board inspection device of FIG. 1 according to the present invention.

A mounting inspection device 10 shown in FIG. 1, which is the printed circuit board inspection device of the present invention, comprises imaging devices including a camera 11 and a laser measuring machine 12, and an inspecting section 10a. The inspecting section 10a is configured as a computer, including a CPU (Central Processing Unit), a display unit, an input unit, and an external storage unit. The inspecting section 10a installs a program or data recorded in a recording medium such as CD-ROM into the external storage unit through an optical disc drive device or the like, loads the program or the data into the main memory, and processes the program or the data by the CPU so as to provide functions for inspecting printed circuit boards according to the present invention.

The inspecting section 10a provides a function for checking the quality by not merely performing print pattern matching of a solder paste and examining the solder shapes and deformation after mounting parts, but also calculating the amount of the solder paste not covered by electrodes after mounting the parts.

More specifically, the inspecting section 10a provides a function for storing image data, which image data is captured by the camera 11 and the laser measuring machine 12 and shows a mounted state of the part with respect to the solder paste, into a storage unit (not shown), a function for calculating the amount of solder not covered by an electrode of the part mounted on the solder paste, and a function for determining whether solder paste is incorrectly printed if the calculated non-covered amount is greater than a predetermined upper limit or lower than a predetermined lower limit.

The inspecting section 10a further provides a function for finding a mounted state of the part on the solder paste based on the image data, and a function for determining that the part is not correctly mounted if the found mounted state is different from a predetermined correct state.

The inspecting section 10a further provides a function for finding the height of the part mounted on the solder paste relative to the surface of the printed circuit board, and a function for determining that the solder paste is insufficient or that the part is missing if the height is smaller than a predetermined lower limit associated with the part and determining that a foreign material is adhered to the solder paste if the height is greater than a predetermined upper limit associated with the part.

The inspecting section 10a further provides a function for finding the height of the part mounted on the solder paste relative to the surface of the printed circuit board and detecting whether the solder paste has a portion not covered by the electrode at a position lower than the height of the part, a function for determining that the solder paste is insufficient or that the part is missing if the found height of the part is smaller than a predetermined lower limit associated with the part, determining that a foreign material is adhered to the solder paste if the found height of the part is greater than a predetermined upper limit associated with the part, and determining that the solder paste is insufficient if it is detected that the solder paste does not have a portion not covered by the electrode at a position lower than the height of the part.

The inspecting section 10a further provides a function for detecting insufficiency of the solder paste, print misalignment, part misalignment on the solder paste, missing parts, wrong parts, parts mounted in a wrong orientation, and lifted parts, and a function for detecting insufficiency of the solder paste, print misalignment, print smudge, and foreign materials on the solder paste based on image data, which is captured by the camera 11 and the laser measuring machine 12 before mounting the part, showing the solder paste printed on the printed circuit board.

To provide these functions, the inspecting section 10a has a foreign material inspecting section 13, a print smudge inspecting section 14, a solder insufficiency inspecting section 15, a print misalignment inspecting section 16, a part misalignment inspecting section 17, a missing part inspecting section 18, an orientation error inspecting section 19, and an under-electrode solder insufficiency inspecting section 20.

The camera 11 and the laser measuring machine 12 can be used in combination for inspecting a state of the solder printed on the printed circuit board, a state of the mounted part, and a state of the solder under the electrode of the part. The camera 11 and the laser measuring machine 12 are not necessarily used in combination, and it is possible to use only one of them.

The inspecting section 10a provides a function for inspecting a state of the solder printed on the printed circuit board before part mounting, and a function for inspecting a state of the mounted part and a state of the solder printed on the printed circuit board after the part mounting. To provide the function for inspecting a state of the solder printed on the printed circuit board before the part mounting, the inspecting section 10a includes the foreign material inspecting section 13 for detecting foreign materials, the print smudge inspecting section 14 for detecting print smudge due to excess solder, the solder insufficiency inspecting section 15 for detecting solder insufficiency, and the print misalignment inspecting section 16 for detecting solder print misalignment.

To provide the function for inspecting the mounted part, the inspecting section 10a includes the part misalignment inspecting section 17 for detecting misalignment of the mounted part, the missing part inspecting section 18 for checking missing parts, the orientation error inspecting section 19 for detecting parts mounted in a wrong orientation, the under-electrode solder insufficiency inspecting section 20 for detecting solder insufficiency under the electrode of the part, a solder deformation inspecting section (not shown) for inspecting deformation of the solder under the electrode of the part, and a wrong part inspecting section (not shown) for detecting parts mounted in a wrong position.

The print smudge inspecting section 14, the solder insufficiency inspecting section 15, and the print misalignment inspecting section 16 serve not only in inspections before the part mounting but also in inspections after the part mounting.

FIG. 2 illustrates an example of a configuration of a printed circuit board assembly inspection line comprising a solder printer 30 for printing a solder paste in a predetermined pattern on pads (electrodes) of the printed circuit board, a part mounting device 40 for mounting area array parts and the like at predetermined positions, a mounting inspection device 10 which is the printed circuit board inspection device of the present invention shown in FIG. 1, a part mounting device 50 for mounting large parts such as connectors on predetermined positions, and a reflow oven 60 for heating and melting the solder so as to solder electrodes of the mounted parts onto the pads.

There are two types of printed circuit board assembly lines. One is the type that includes different types of part mounting devices, and the other one is the type that includes the same type of part mounting devices. The number of the part mounting devices is not limited to two.

With this printed circuit board assembly and inspection line configuration, the mounting inspection device 10 is able to detect the cause of defects before soldering in the reflow oven 60. Therefore, occurrence of defects can be significantly reduced while assuring high density mounting. Moreover, such a line configuration allows changing of the position of the mounting inspection device 10 depending on the type of parts to be mounted. Accordingly, high-mix variable-volume production is easily achieved without increasing investment in inspection equipment and setup time.

The following describes inspection operations of the inspecting section 10a of FIG. 1 with reference to FIGS. 3A-16B.

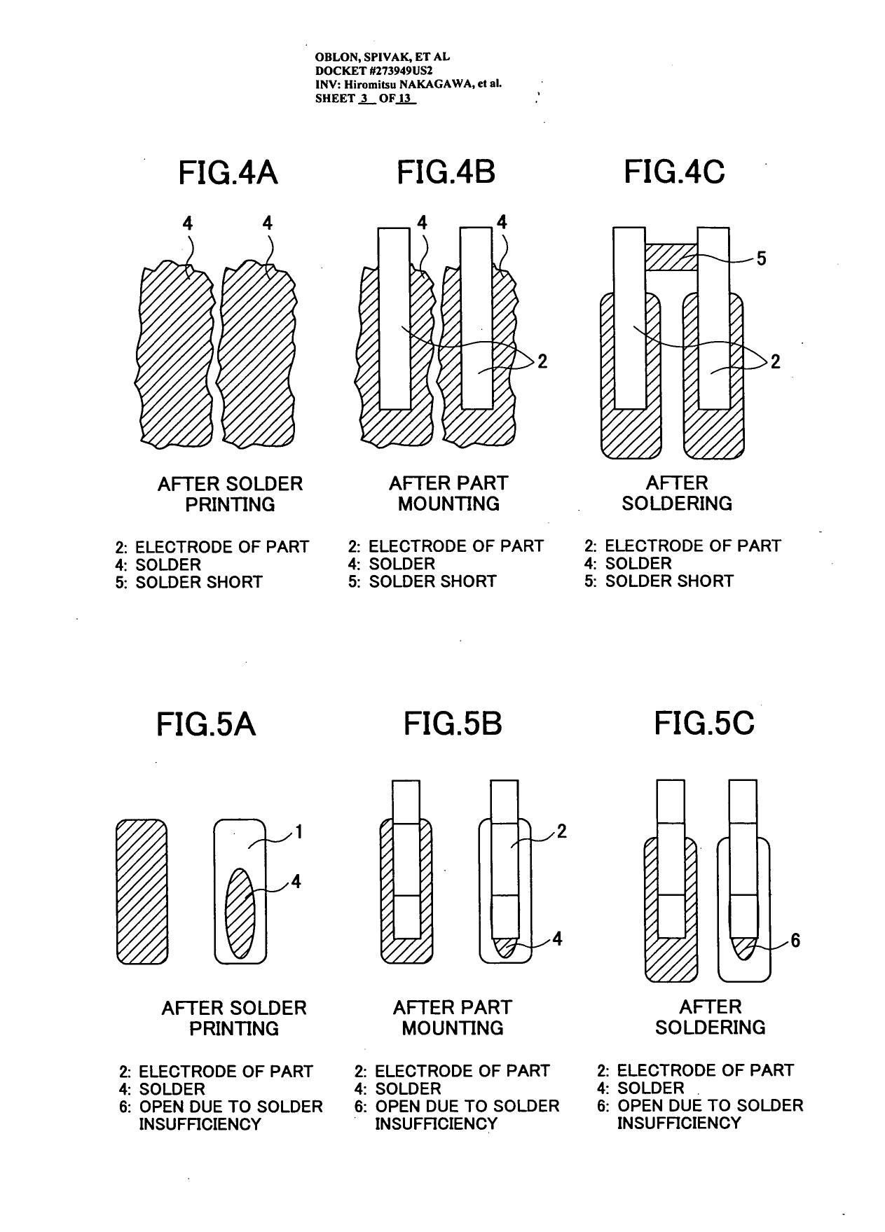

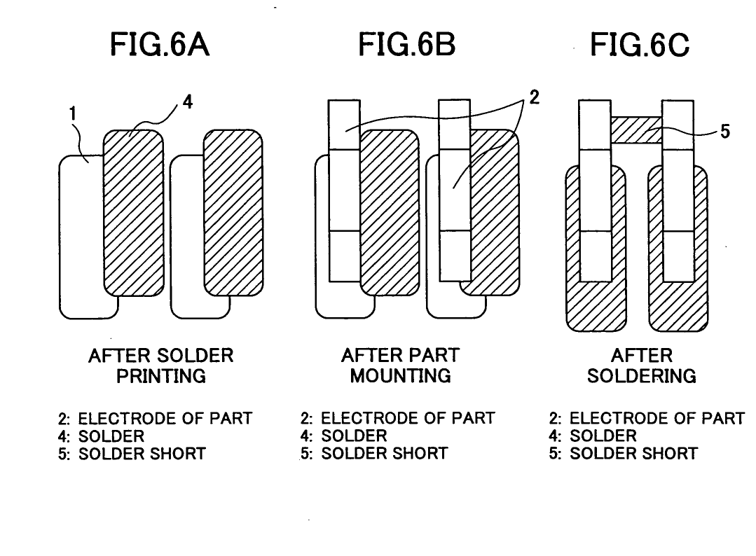

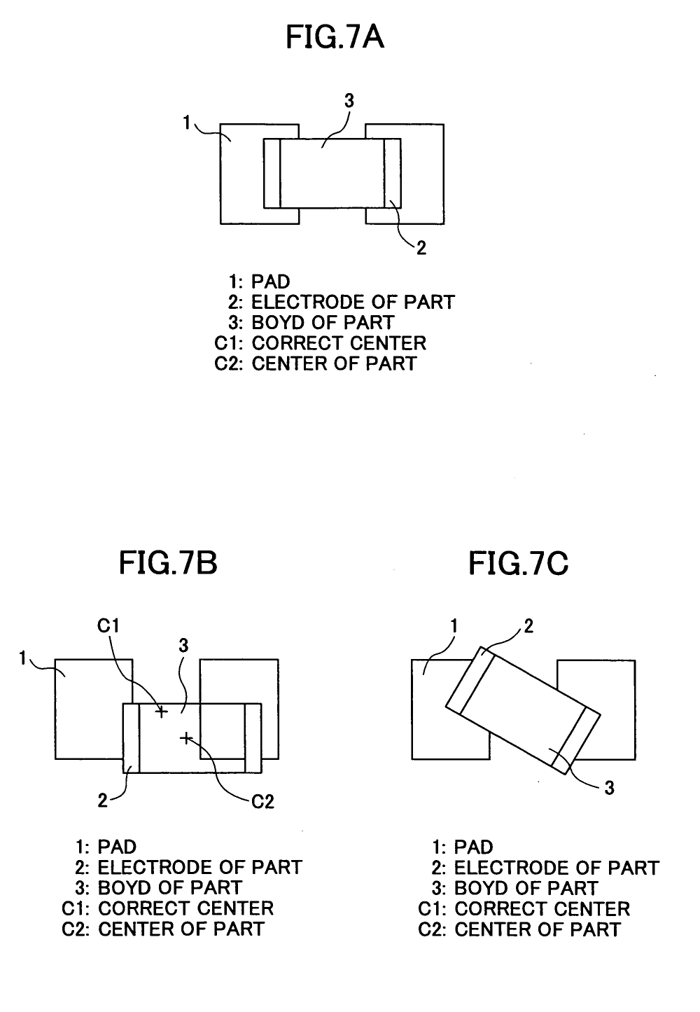

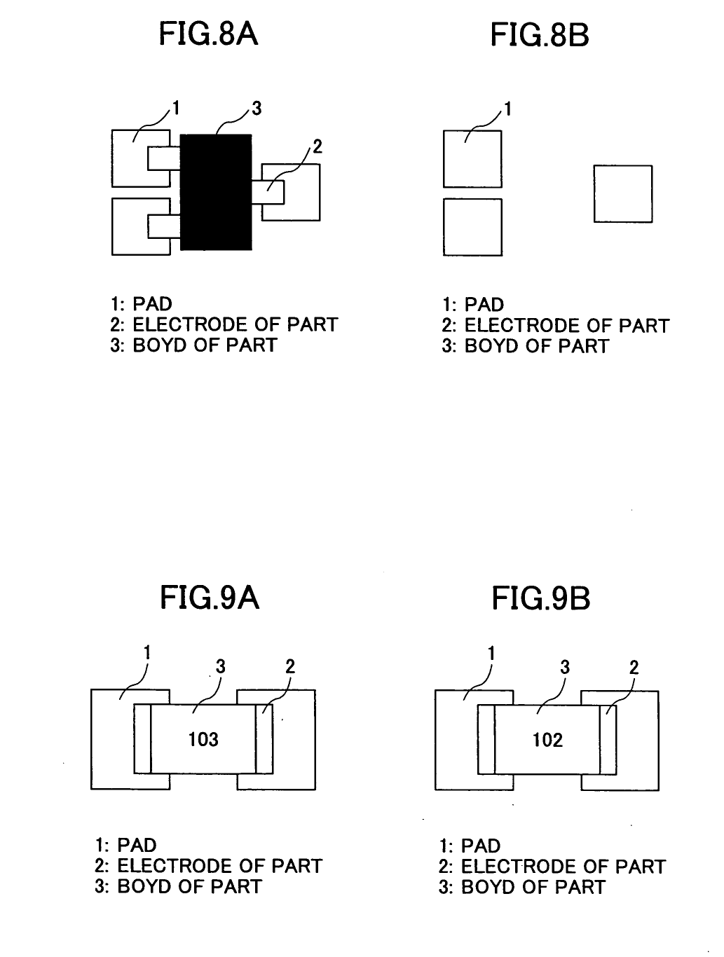

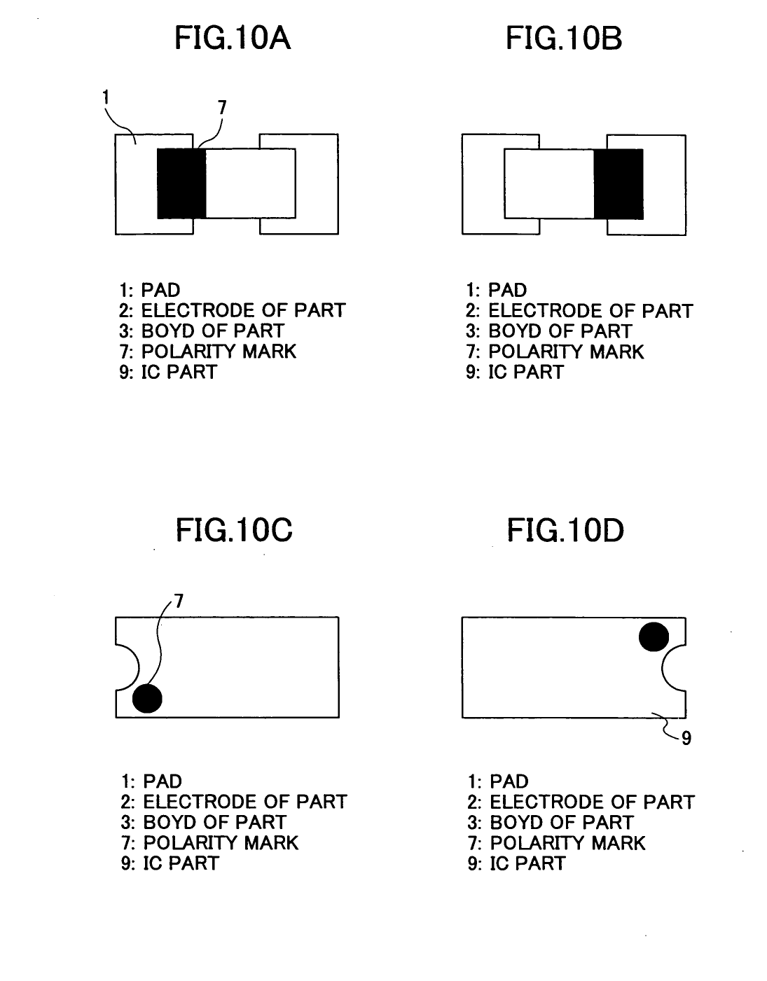

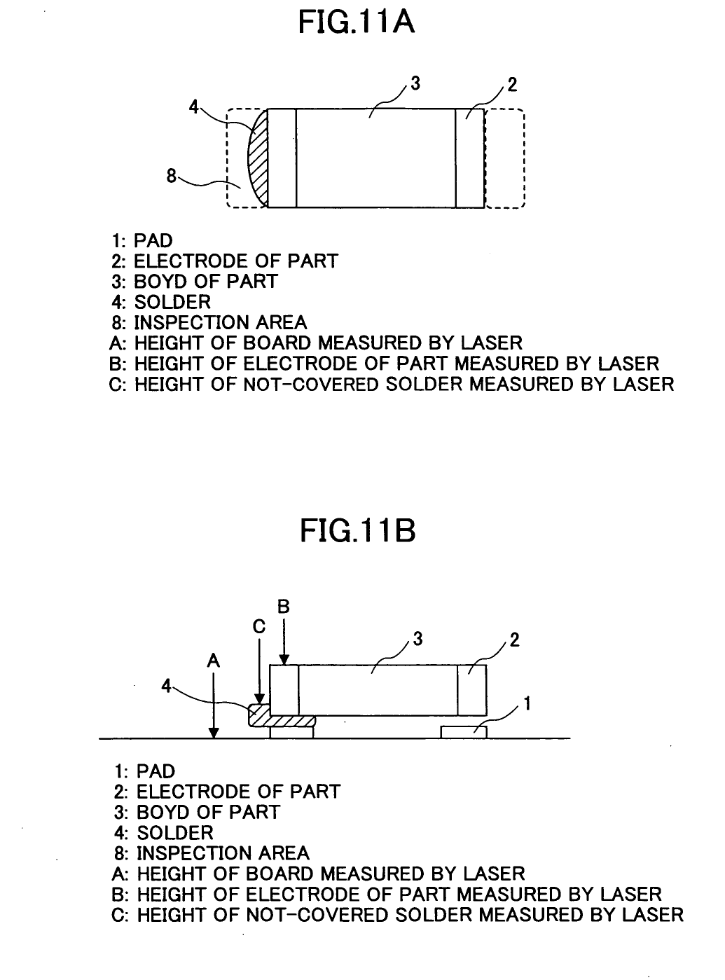

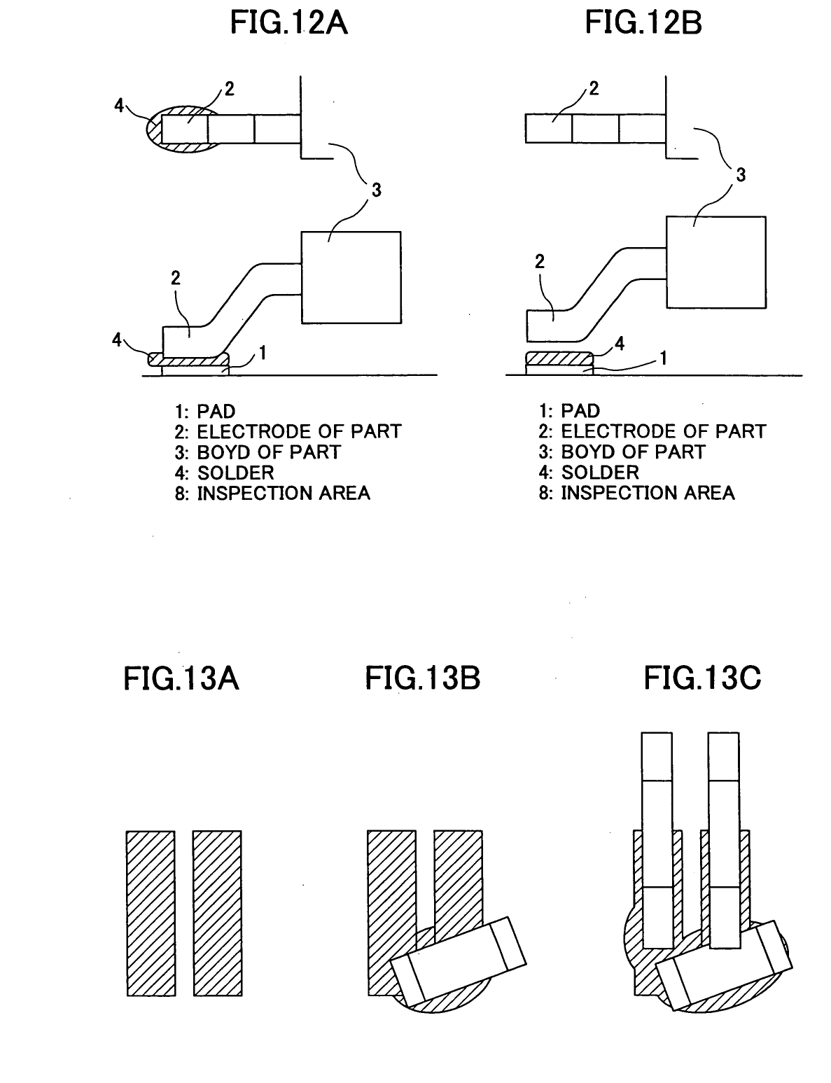

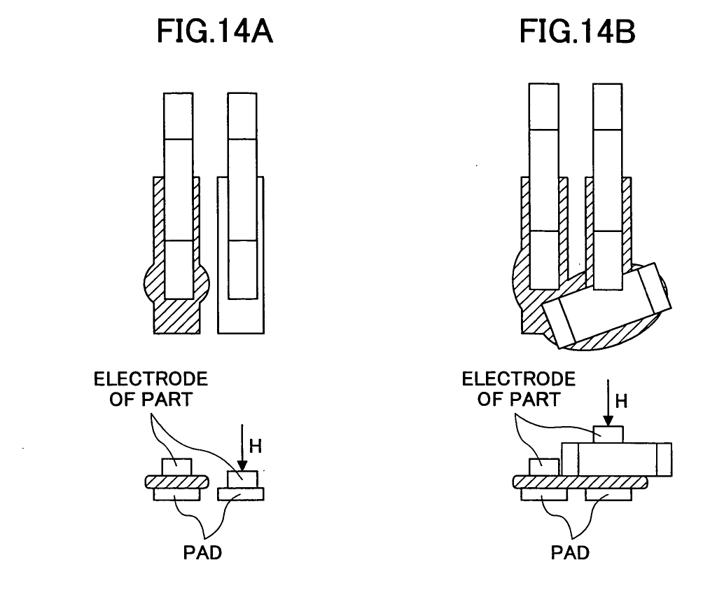

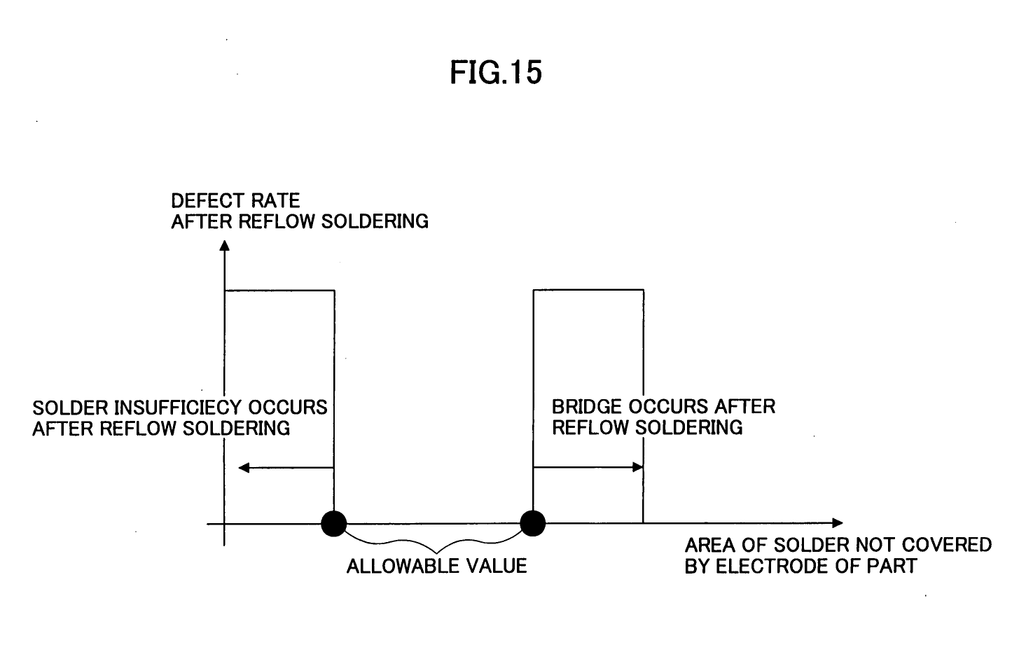

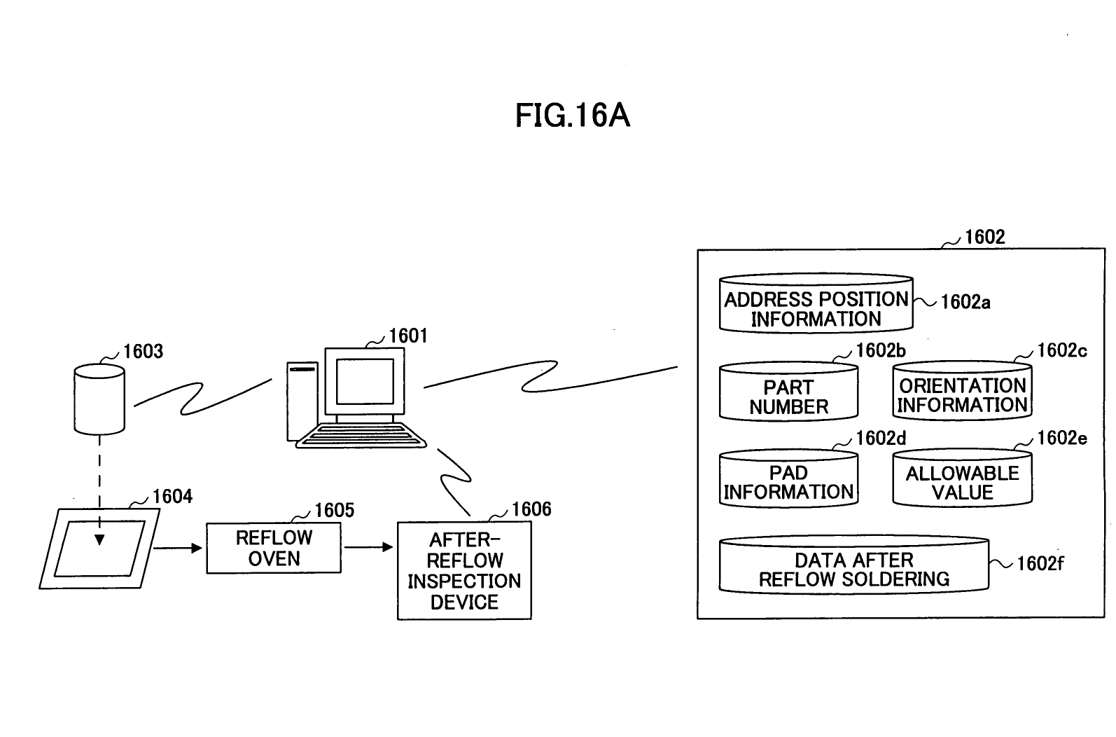

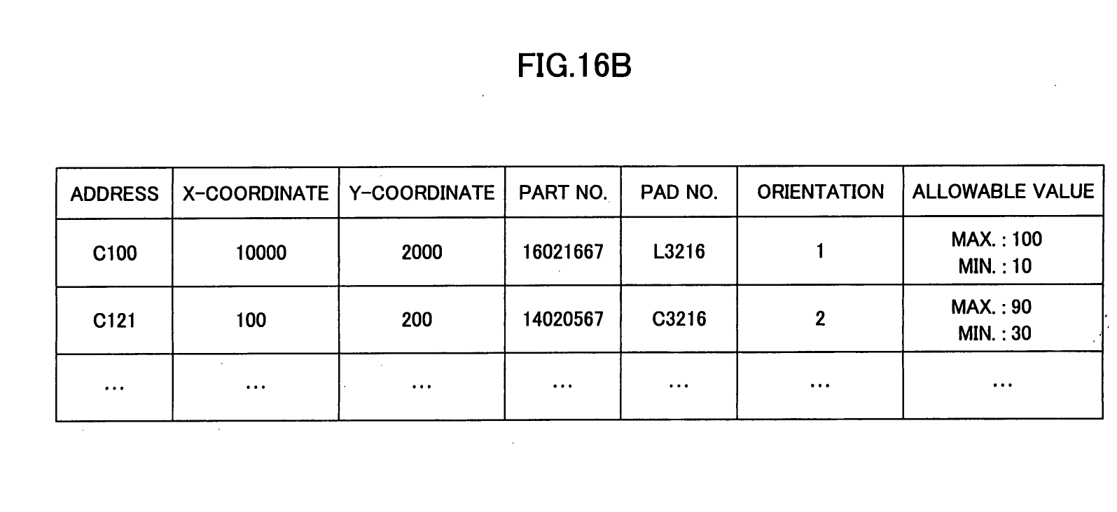

FIGS. 3A and 3B illustrate a first example of the operation of the printed circuit board inspection device of FIG. 1. FIGS. 4A-4C illustrate a second example of the operation of the printed circuit board inspection device of FIG. 1. FIGS. 5A-5C illustrate a third example of the operation of the printed circuit board inspection device of FIG. 1. FIGS. 6A-6C illustrate a fourth example of the operation of the printed circuit board inspection device of FIG. 1. FIGS. 7A-7C illustrate a fifth example of the operation of the printed circuit board inspection device of FIG. 1. FIGS. 8A and 8B illustrate a sixth example of the operation of the printed circuit board inspection device of FIG. 1. FIGS. 9A and 9B illustrate a seventh example of the operation of the printed circuit board inspection device of FIG. 1. FIGS. 10A-10D illustrate an eighth example of the operation of the printed circuit board inspection device of FIG. 1. FIGS. 11A and 11B illustrate a ninth example of the operation of the printed circuit board inspection device of FIG. 1. FIGS. 12A and 12B illustrate a tenth example of the operation of the printed circuit board inspection device of FIG. 1. FIGS. 13A-13C illustrate an eleventh example of the operation of the printed circuit board inspection device of FIG. 1. FIGS. 14A and 14B illustrate a twelfth example of the operation of the printed circuit board inspection device of FIG. 1. FIG. 15 illustrates a thirteenth example of the operation of the printed circuit board inspection device of FIG. 1. FIGS. 16A and 16B illustrate an example of a system configuration of the printed circuit board inspection device of FIG. 1 and an example of a table structure of a database thereof, respectively.

FIGS. 3A and 3B illustrate an example of a foreign material inspection. Defects of area array parts such as BGA and CSP include an open (imperfect contact) due to a foreign material (body 3 of a part to be mounted) that has unexpectedly slipped in between an electrode of a mounted part and solders 4 printed on the pads 1 of the printed circuit board. This inspection is performed to detect such a foreign material (body 3 of a part) shown in FIGS. 3A and 3B.

A foreign material (body 3 of a part) such as a chip part that is failed to be mounted or a piece of a tape of a part supply cassette is sometimes unexpectedly put on the printed circuit board depending on the state of the part mounting device (40) after the solder is printed by the solder printer (30). FIG. 3B shows a state (defective state) where such a foreign material is put on an area on which area array parts such as BGA and CSP are mounted in a subsequent process. If the body 3 of the incorrectly mounted part shown in FIG. 3B is not removed, electrodes 2 of the part are connected onto the solders 4.

The mounting inspection device 10 according to this embodiment captures image data of the state of the solders 4 on the pads 1 in a mount area on the printed circuit board with use of the camera (11), measures the area of the solders 4 based on the image data, and compares the measured area with an allowable value so as to check the presence of the foreign material (body 3 of the part). If the foreign material (body 3 of the part) is present, the area of the solders 4 that can be observed is reduced. Therefore, the presence of the foreign material (body 3 of the part) can be confirmed based on the area of the solders 4 portion.

It is difficult to detect such defects caused by the presence of a foreign material (body 3 of the part) after the area array parts are mounted on and soldered to the foreign material (body 3 of the part), because joint sections are located under the body 3 and therefor can not be seen from outside. If this foreign material inspection is not performed, these defects are not detected until a function inspection is performed. According to this embodiment, the presence of a foreign material (body 3 of the part) is checked before the part mounting. This makes it possible to take a measure such as removal of the foreign material (body 3 of the part) before the part mounting, and thereby avoiding difficult repairs after the soldering.

FIGS. 4A-4C illustrate an example of a print smudge inspection. FIG. 4A shows a state where the solders 4 are spread outside the area of the pads due to solder oversupply in a solder printing process. FIG. 4B shows a state where parts are mounted on the solders 4 of FIG. 4A. In the case the solders 4 of FIG. 4B are heated and melted for soldering in the reflow oven (60), although some portions of solders 4 are moved onto the pads, some portions possibly form a short 5 between the parts as shown in FIG. 4C.

According to this embodiment, occurrence of print smudge is checked by capturing image data of the print state of the mount area on the printed circuit board with use of the camera (11) before the part mounting, measuring the area of the solders based on the image data, and comparing the measured area with an allowable value so as to check the presence of print smudge. If there is print smudge, the area of the solders that can be observed is larger than a predetermined upper limit. Therefore, the print smudge can be detected based on the measured area of the solders.

FIG. 5A-5C illustrate an example of a solder insufficiency inspection. FIG. 5A shows a state where the solder 4 is printed on only a part of the pad 1 due to solder undersupply in the solder printing process. FIG. 5B shows a state where the part is mounted on the solder 4 of FIG. 5A. If the solder 4 of FIG. 5B is heated and melted for soldering in the reflow oven (60), an open 6 is formed as shown in FIG. 5C due to solder insufficiency.

In this inspection, solder insufficiency is detected by capturing image data of the solders 4 on the pads 1 in the mount area on the printed circuit board with use of the camera (11), measuring the area of the solders 4 based on the image data, and comparing the measured area with a predetermined allowable value. For example, if the measured area of the solders r is equal to or lower than a predetermined lower limit, it is determined that the solders are insufficient. This inspection can also be performed in the same way after the part mounting.

FIG. 6A-6C illustrate an example of a print misalignment inspection. FIG. 6A shows a state where the printed solders 4 are misaligned with the pads 1 although the solder supply amount in the solder printing process is adequate. FIG. 6B shows a state where the parts are mounted on the solders 4 of FIG. 6A. If the solders 4 of FIG. 6B are heated and melted for soldering in the reflow oven (60), although most portions of the solders 4 are moved onto the pads 1, portions printed near the adjacent pad may form a short 5 between the electrodes 2 as shown in FIG. 6C.

According to this embodiment, image data of the states of the pads 1 and the solders 4 in the mount area on the printed circuit board are captured by the camera (11), and occurrence of print misalignment is checked based on the image data. Misalignment may be detected by finding positions of the solders 4 based on the image data of the solders 4 and comparing the found positions with reference positions provided in advance in the form of data. This inspection can also be performed in the same way after the part mounting.

As can be seen, in this mounting inspection device, defects due to solder print states that occur after the melting and reflow soldering can be detected both before (FIG. 6A) and after the part mounting (FIG. 6B), and defects that occur after the soldering can be prevented by controlling solder supply positions and the solder supply amount.

FIGS. 7A-7C illustrate an example of a part misalignment inspection. The body 3 and the electrodes 2 of the part shown in FIG. 7A are correctly mounted on the pads 1. However, in some cases, the body 3 of the part is parallelly displace as shown in FIG. 7B, or is rotated as shown in FIG. 7C.

According to this embodiment, image data of the states of the pads 1, the body 3 of the part, and the electrodes 2 of the part in the mount area on the printed circuit board are captured by the camera (11), and occurrence of part misalignment is checked based on the image data. Misalignment such as parallel displacement of FIG. 7B can be detected by finding a correct center C1 between the pads 1 on mount positions and a part center C2 of the body 3 of the part, and comparing and matching the correct center C1 and the part center C2. Misalignment such as the rotation of FIG. 7C can be detected by finding the positions of the outlines of the body 3 and the electrodes 2 of the part, and comparing the positions with correct positions.

FIGS. 8A and 8B illustrate an example of a missing part inspection. FIG. 8A shows a state where the body 3 and the electrodes 2 of the part are correctly mounted across the pads 1, while FIG. 8B shows a state where the part is missing due to a part supply mistake and the pads 1 are remained without the part.

According to this embodiment, image data of a state around the pads 1 in the mount area on the printed circuit board is captured by the camera (11), and missing parts are checked based on the image data. If the outlines of the body 3 and the electrodes 2 of the part are not detected in the mount area on the printed circuit board, it is determined that the part is missing. In this inspection, detection of missing parts may also be performed by checking the presence of a region that is higher than the surfaces of the pads 1 by the height of the part in the mount area for the part with use of the laser measuring machine (12).

FIGS. 9A and 9B illustrate an example of a wrong part inspection. FIG. 9A shows a state where a body 3 and electrodes 2 of a correct part 103 are mounted across the pads 1, while FIG. 9B shows a state where a body 3 and electrodes 2 of a wrong part 102 are mounted due to a part supply mistake.

According to this embodiment, a wrong part is detected by capturing image data of a state around the pads 1 in the mount area on the printed circuit board with use of the camera (11), and reading a part ID, e.g. “102”, printed on the top of the body 3, and comparing the read part ID with a correct part ID, e.g. “103”.

FIGS. 10A-10D illustrate an example of an orientation error inspection. FIG. 10A shows a state where the part is mounted across the pads 1 in a correct orientation, while FIG. 10B shows a state where the part is mounted in the opposite orientation due to a part supply mistake.

According to this embodiment, such an orientation error is detected by capturing image data of a state around the pads 1 in the mount area on the printed circuit board with use of the camera (11), and reading a polar mark 7 based on the image data, and comparing the read polar mark 7 with a correct orientation. An IC part 14 shown in FIGS. 10C and 10D is provided with a polar mark having a shape different from the polar mark 7 of FIGS. 10A and 10B. The orientation error inspection can be performed in the same manner as described above with respect to the entire circuit board on the IC part 14 having such a polar mark 7.

FIGS. 11A and 11B illustrate an example of an inspection of a solder that is smaller than an electrode of a chip part. FIG. 11B shows a side view of the body 3 of the part mounted on the pads 1 of the printed circuit board and the electrodes 2 of the part, and FIG. 11A shows a top view of FIG. 11B. As shown in FIGS. 11A and 11B, there is a case where the solder 4 is not provided under one of the electrodes 2 of the part due to solder insufficiency or the like.

In this inspection, the mounting inspection device 10 captures an image around the mount area on the printed circuit board with use of the camera (11) before reflow, acquires a section with a color indicating the solder (image data) through image processing, determines whether there is a portion of the solder not covered by the electrode 2 of the part based on the image data, and detects insufficiency of the solder under the electrode based on the determination result.

If there is a sufficient solder under the electrode 2 of the part, a portion of the solder 4 not covered by the electrode 2 of the part can be detected as shown at the left side of FIG. 11A. If the solder is insufficient, a non-covered portion of the solder 4 can not be detected as shown at the right side in FIG. 11A.

Such solder insufficiency under the electrodes can also be detected with use of the laser measuring machine (12). First, a height (A) is measured by irradiating a laser beam onto the surface of the printed circuit board. Next, a height (B) of the electrode 2 of the part is measured by irradiating a laser beam at a position of the electrode 2 of the part based on the position information of the electrode 2. Then, it is determined whether a height (C) between the height (A) of the printed circuit board and the height (B) of the electrode 2 of the part is present, so that the solder insufficiency under the electrode is checked.

FIGS. 12A-12B illustrate an example of an inspection of a solder that is smaller than an electrode of a part (IC part). FIG. 12A shows a state where the solder 4 is in contact with the pad 1 and the electrode 2 of the part. FIG. 12B shows a state where the electrode 2 of the part is not in contact with the solder 4 due to warpage of the electrode 2 of the part. If the solder 4 of FIG. 12B is heated and melted in a subsequent process, a defect such as a lead open occurs.

In this case, a portion of the solder 4 not covered by the electrode 2 can be detected by image capturing and image processing with use of the camera (11) or by height measuring with use of the laser measuring device in the same manner as in the case described above.

FIGS. 13A-13C and 14A-14B illustrate an example of a foreign material inspection. Defects of IC parts and connector parts include openings (imperfect contacts) due to a foreign material that has unexpectedly slipped in between electrodes of a mounted part and solders printed on the pads of the printed circuit board. A foreign material such as a chip part that is failed to be properly mounted is sometimes unexpectedly put on the printed circuit board depending on the state of the part mounting device after printing the solder paste by the solder printer.

FIG. 13B shows a state where such a foreign material is unexpectedly put at a position at which odd-shaped parts such as IC parts and connector parts are mounted in a subsequent process, and FIG. 13C shows a state where the odd-shaped parts are mounted on the foreign material of FIG. 13B.

According to this embodiment, the area of a solder portion not covered by electrodes of the odd-shaped parts is calculated, and the measured area is compared with an allowable value so as to detect the presence of the foreign material. If the foreign material is present, the area of the solder portion that can be observed in image data captured by the camera (11) is reduced. Therefore, the presence of the foreign material can be detected based on the area of the solder portion.

Moreover, as shown in FIGS. 14A and 14B, to identify foreign material adhesion (FIG. 14B) and solder insufficiency (FIG. 14A), after the area of the non-covered solder portion is measured, a height (H) around the electrode of the part is measured. If there is a point higher than a predetermined allowable value (mask thickness), it is identified as foreign material adhesion. If the height (H) is lower than the mask thickness, it is identified as solder insufficiency.

Three-dimensional measuring techniques using a CCD camera or a laser measuring machine, for example, may be employed for the height measurement described above. An example of a technique for measuring an object in three dimensions with use of a CCD camera includes a technique disclosed in Japanese Patent Laid-Open Publication No. 2000-304520 wherein six lights are turned on, the image of reflowed solder fillet is captured by a CCD camera each time the lights are turned on, and the shape of the solder fillet is measured based on the luminance of pixels in the image.

An example of a technique for measuring an object in three dimensions with use of a laser includes a technique disclosed in Japanese Patent Laid-Open Publication No. 07-208948 wherein a laser beam is irradiated onto an object, and the reflected light is measured and computed to find the height of the object, and a technique wherein a plurality of laser beams are irradiated to realize highly accurate measurements.

The following explains “allowable value” with reference to FIG. 15. The “allowable value” is a threshold for identifying an allowable product and a defective product. There are two allowable values in this embodiment as shown in FIG. 15. When the amount of the solder portion not covered by the electrode of the part is smaller than the allowable value at the left side in FIG. 15, solder insufficiency occurs. If the amount is greater than the allowable value at the right side in FIG. 15, a bridge appears.

To find these allowable values, for example, a CCD camera or a laser measuring machine is moved to coordinates of a specified address so as to measure the area of the non-covered amount of the solder. Then, based on quality data after reflow soldering, if solder insufficiency occurs, the allowable value is set to a value of the measured non-covered area of the solder to which “1” is added. On the other hand, if a bridge occurs after reflow soldering, the allowable value is set to a value of the measured non-covered area of the solder from which “1” is subtracted.

FIG. 16A illustrates an example of a system configuration of the printed circuit board inspection device of this embodiment, comprising a printed circuit board inspection device 1601 of this embodiment for executing processes by a CPU according to a program, a database 1602 held by the printed circuit board inspection device 1601, a CCD camera or a laser measuring device 1603, a printed circuit board 1604 to be inspected, a reflow oven 1605, and an after-reflow inspection device 1606. This printed circuit board inspection device 1601 is configured to send and receive the data 1602 via a network. The data 1602 includes address position information 1602a, part numbers 1602b, orientation information 1602c, pad information 1602d, and allowable values (thresholds for allowable products) 1602e, and result (data) 1602f after reflow soldering. FIG. 16B illustrates an example of a table structure of the database 1602 shown in FIG. 16A.

As described above with reference to FIGS. 1-16B, in this embodiment, states of solders printed on a printed circuit board are inspected after electrodes of parts are mounted on the solders, states of the mounted parts, and states of the solders under electrodes of the mounted parts are also inspected.

More specifically, the quality of the solders are examined by computing the area of the solder not covered by the electrodes based on image data obtained by the camera or the laser measuring device, and comparing the computed area with predetermine allowable values. With these operations, a presence of foreign materials, solder insufficiency, print smudge, and print misalignment can be detected after mounting the parts.

In addition, part misalignment, missing parts, wrong parts, orientation errors of the mounted parts, solder insufficiency under the electrodes of the mounted parts, and openings due to lead curvature can also be detected after mounting the parts.

The use of the printed circuit board inspection device of the present invention eliminates the need for inspections after the melting and soldering process. This is very effective and efficient in view of future improvements in high density mounting techniques. In particular, it is sometimes difficult to check the appearance of joint sections because of interference of the height of mounted parts in inspections after soldering. If solder joint sections are located under the body of the mounted parts or the like, soldered states can not be checked by inspections after reflow soldering. If the printed circuit board inspection device of the present invention is employed, there is no need to perform such inspections after the reflow soldering. That is, because the printed circuit board inspection device of the present invention can predict defects that will occur after the soldering, areas that can not be checked after the soldering can be checked before the soldering. Therefore, circulation of defective printed circuit boards can be prevented. This makes it possible to provide high-quality and efficient printed circuit boards and electronic devices.

While the present invention has been described in terms of a preferred embodiment with reference to the examples illustrated in FIGS. 1-16B, it will be apparent to those skilled in the art that variations and modifications may be made without departing from the scope of the invention.

It is understood that the inspecting section 10a does not necessarily have a computer including a keyboard and an optical disc drive device is used in the above embodiment. A computer not including them may be used alternatively. While an optical disc is used as a recording medium in the above embodiment, a FD (Flexible Disk) and the like may be used alternatively. As for program installation, the program may be downloaded and installed via a network with use of a communication device.

The present application is based on Japanese Priority Application No. 2004-193001 filed on Jun. 30, 2004, with the Japanese Patent Office, the entire contents of which are hereby incorporated by reference.

What is claimed is:

1. A printed circuit board inspection device for a printed circuit board on which a solder paste is printed and at least one part is mounted on the solder paste, the device comprising:
a first section to receive image data captured by an imaging device, the image data showing the part mounted on the solder paste, and the image data being stored in a storage unit;
a second section to read out the image data from the storage unit and, based on the read-out image, to calculate an amount of the solder paste not covered by an electrode of the part mounted on the solder paste; and
a third section to determine that the solder paste is incorrectly printed if the amount of not-covered solder paste is greater than a predetermined upper limit or smaller than a predetermined lower limit.

2. The printed circuit board inspection device as claimed in claim 1, further comprising:
a fourth section to read out the image data from the storage unit and acquire mounted state information of the part mounted on the solder paste based on the image data; and
a fifth section to determine that the part is not correctly mounted if the mounted state information of the part acquired by the fourth section is different from predetermined correct state information.

3. The printed circuit board inspection device as claimed in claim 1, further comprising:
a sixth section to find the height of the part mounted on the solder paste relative to a surface of the printed circuit board; and
a seventh section to determine that the solder paste is insufficient or the part is missing if the height found by the sixth section is smaller than a lower limit associated with the part in advance, and determine that a foreign material is adhered on the solder paste if the height found by the sixth section is greater than an upper limit associated with the part in advance.

4. The printed circuit board inspection device as claimed in claim 1, further comprising:
an eighth section to find the height of the part mounted on the solder paste and detect whether the solder paste has a portion not covered by the electrode at a position lower than the height of the part; and
a ninth section to determine that the solder paste is insufficient or the part is missing if the height found by the eighth section is smaller than a lower limit associated with the part in advance, determine that a foreign material is adhered on the solder paste if the height found by the eighth section is greater than an upper limit associated with the part in advance, and determine that the solder paste is insufficient if the eighth section detects that the solder paste does not have a portion not covered by the electrode at a position lower than the height of the part.

5. The printed circuit board inspection device as claimed in claim 1, wherein the imaging device comprises either one or both of a camera and a laser measuring machine.

6. The printed circuit board inspection device as claimed in claim 1, further comprising:
a tenth section to read out the image data from the storage unit so as to detect insufficiency of the solder paste, print misalignment of the solder paste, misalignment of the part on the solder paste, missing parts, wrong parts, parts mounted in a wrong orientation, and lifted parts.

7. The printed circuit board inspection device as claimed in claim 1, further comprising:
an eleventh section to detect insufficiency of the solder paste, print misalignment, print smudge, and foreign materials on the solder paste based on the image data, which is captured by the imaging device before mounting the part, showing the solder paste printed on the printed circuit board.

8. A computer-readable medium having a program recorded thereon for causing a computer to function as a printed circuit board inspection device for inspecting a printed circuit board on which a solder paste is printed and at least one part is mounted on the solder paste, the program comprising:
a first process of receiving image data captured by an imaging device, the image data showing the part mounted on the solder paste, the image data being stored in a storage unit;
a second process of reading out the image data from the storage unit and, based on the read-out image, calculating an amount of the solder paste not covered by an electrode of the part mounted on the solder paste; and
a third process of determining that the solder paste is incorrectly printed if the amount of not-covered solder paste is greater than a predetermined upper limit or smaller than a predetermined lower limit.

9. A printed circuit board assembly inspection line system, comprising:
a solder printing device to print a solder paste on a printed circuit board;
a part mounting device to mount at least one part on a printed circuit board on which the solder paste is printed by the solder printing device;
a printed circuit board inspection device of claim 1 to determine whether the printed circuit board includes a defect by inspecting the part mounted by the part mounting device and the solder paste printed by the solder printing device; and
a reflow oven to solder the part by heating the solder paste if the printed circuit board inspection device determines that the printed circuit board does not include a defect.
